(19) United States
(12) Patent Application Publication
(10) Pub. No.: US 2007/0260731 A1
(43) Pub. Date: Nov. 8, 2007

(54) METHOD AND APPARATUS FOR PROVIDING SECURITY IN A REMOTE COMMUNICATION SYSTEM

(75) Inventors: Balaji Thulasiraman Pitta, Bangalore (IN); Yayah Iyash Kammukutty, Bangalore (IN)

Correspondence Address: PETER VOGEL;GE HEALTHCARE, 3000 N. GRANDVIEW BLVD., SN-477, WAUKESHA, WI, 53188, US

(73) Assignee: General Electric Company, Schenectady, NY (US)

(21) Appl. No.: 11/381,157

(22) Filed: May 2, 2006

(51) Int. Cl. G06F 15/173

(52) U.S. Cl. 709/225

(57) ABSTRACT

A method for selectively guarding static interface regions and dynamically created interface regions in a host system having a host system user interface includes designating at least one static interface regions of the host system user interface as limited remote access interface regions. The host system also identifies creation of the dynamically created interface regions of the host system user interface while the host system is in operation. One or more dynamic interface regions of the host system user interface may be designated as limited remote access interface regions. The limited remote access interface regions present in screen data for the host system user interface are modified and sent to a remote system for display. Other embodiments provide a remote communication system comprising a host system and a remote system incorporating the method of selectively guarding the static interface regions and dynamically created interface regions.

### CROSS-REFERENCE TO RELATED PATENT APPLICATIONS

This application is related to commonly assigned US Published Patent Application No. US20050078082A1, Muralidharan, et al. entitled “Method and Apparatus For Selectively Blocking Remote Action,” incorporated by reference in its entirety.

### FIELD OF THE INVENTION

This invention relates generally to a remote configuration and interaction of a mechanical and/or radiological system. More specifically, the present invention relates to the remote configuration, remote operation, and/or remote servicing of a medical diagnostic system while prohibiting remote implementation of certain functions of the system.

### BACKGROUND OF THE INVENTION

Traditionally medical facilities have concentrated their efforts on providing the best possible medical services to patients. The quality of medical services has progressed extremely quickly in the medical imaging disciplines or modalities.

Medical imaging systems are typically complex and require periodic maintenance of the system and or periodic instruction of the technicians or personnel using the system. Furthermore, medical imaging systems have become more commonplace at rural or less centralized locations. However, the availability of qualified service engineers and/or instructors may be limited at these locations. The limited numbers of qualified personnel and the prevalence of the imaging systems may, therefore, make remote service or instruction desirable where possible. This allows engineers and/or instructors to interact with imaging systems and facility personnel remotely.

It may also be desirable to limit the possible actions a remote operator is allowed to perform, such as to prevent remote actions leading to the movement of moving components, the emission of X-rays, and/or the generation of strong magnetic fields. Also, as the remote operator cannot visually monitor the physical location of the imaging system, it may be desirable to prevent the remote operator from taking actions affecting the site.

Thus, there exists a need for providing security to the critical components in the main imaging system. This can be achieved by providing a remote operator, such as a service engineer and/or an instructor, with a limited visual interface and/or a limited input interface in relation to system operating conditions. In this manner, the remote operator is only presented with information or options corresponding to the desired scope of the remote task.

Some of the prior arts solutions suggest a method for providing security in a remote service application by limiting the accessibility of the critical components. The solutions suggest a method of masking the critical components in the host system based on the operating condition of the host system. These systems, however, assign fixed levels of security at the start up of the host system.

However, there is a chance that new interface regions may be created after the startup of the host system. For example, in PET applications the interface regions can be created or destroyed dynamically. These dynamically created interface regions need to be allotted with desired levels of security during the operation of the system.

Thus, there exists a need for an effective method for providing security to static as well as dynamically created interfaces of a host system in communication with a remote system. Also, there is a need for an efficient communication system communicating between the host imaging system and a remote system without affecting the security of the critical components in the imaging system.

### SUMMARY OF THE INVENTION

In one embodiment, a method for selectively guarding static interface regions and dynamically created interface regions in a host system having a host system user interface includes designating at least one static interface region of the host system user interface as a limited remote access interface region, identifying creation of the dynamically created interface regions of the host system user interface while the host system is in operation, designating at least one dynamically created interface region of the host system user interface as a limited remote access interface region, and modifying the limited remote access interface regions present in screen data for the host system user interface to be sent to a remote system for display.

In another embodiment, a computer program, provided on one or more computer readable media for selectively guarding static interface regions and dynamically created interface regions in a host system having a host system user interface includes a routine for designating at least one static interface region of the host system user interface as a limited remote access interface region, a routine for identifying creation of the dynamically created interface regions of the host system user interface while the host system is in operation, routine for designating at least one dynamically created interface region of the host system user interface as a limited remote access interface region, and a routine for modifying the limited remote access interface regions present in screen data for the host system user interface to be sent to a remote system for display.

In yet another embodiment, a remote communication system includes a host medical imaging system having a host user interface including static user interface regions and dynamically created user interface regions. The host medical imaging system includes a host processor configured to designate at least one static user interface region as a limited remote access interface region, to identify creation of the dynamically created user interface regions while the host medical imaging system is in operation, to designate at least one dynamically created user interface region as a limited remote access interface region, to identify a component identifier for each limited remote access interface region and to modify the limited remote access interface regions, and a memory coupled to the host processor and configured to store component identifiers for limited remote access interface regions in a configuration file. The remote communication system also includes at least one remote system configured to communicate with the host medical imaging system and to display the host user interface and a communication link coupled between the host medical imaging system and the at least one remote system and configured to transmit the modified limited remote access interface regions to the remote system.

### BRIEF DESCRIPTION OF THE DRAWINGS

The foregoing and other advantages and features will become more fully understood from the following detailed description, taken in connection with the accompanying drawings, in which:

FIG. 1 is a schematic block diagram of a remote communication system including certain functional components of an exemplary imaging system configured for remote communication with a remote system in accordance with an embodiment;

FIGS. 2A and 2B are flowcharts illustrating a method of providing security for interface regions of a host system user interface in a remote communication system in accordance with an embodiment; and

FIGS. 3A and 3B are flowcharts illustrating a method of providing security for interface regions of a PET application user interface in a remote communication system in accordance with an exemplary embodiment.

### DETAILED DESCRIPTION OF THE INVENTION

In the following description, reference is made to the accompanying drawings that form a part hereof, and in which is shown by way of illustration, specific embodiments which may be practiced. These embodiments are described in sufficient detail to enable those skilled in the art to practice the embodiments, and it is to be understood that embodiments may be utilized and that logical, mechanical, electrical and other changes may be made without departing from the scope of the embodiments. The following detailed description is, therefore not to be taken in a limiting sense.

Various embodiments provide a method for selectively guarding static interface regions and dynamic interface regions in a host system having a host system user interface, the host system including a medical imaging device. Various specific embodiments include a remote communication system in medical imaging.

Embodiments may be implemented in connection with any medical imaging system such as, for example, a computed tomography (CT) imaging system, an magnetic resonance imaging (MRI) system, a tomosynthesis system, an electron beam tomography (EBT) imaging system, a positron emission tomography (PET) imaging system, a digital imaging system, etc.

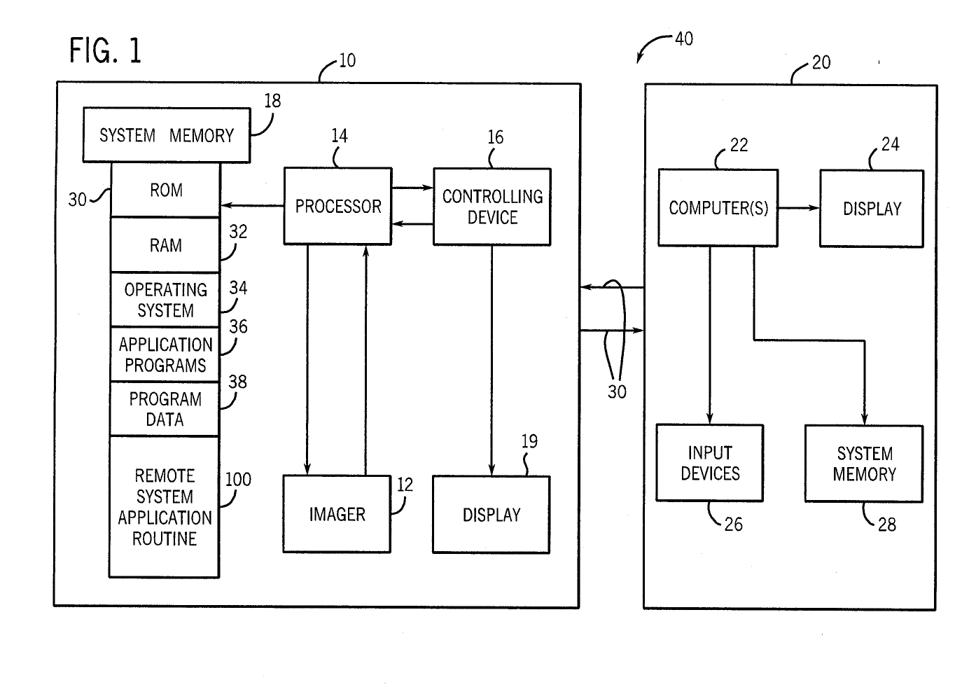

FIG. 1 is a schematic block diagram of a remote communication system including certain functional components of an exemplary imaging system configured for remote communication with a remote system in accordance with an embodiment. The remote communication system 40 shown in FIG. 1 includes a host system 10 and a remote system 20. The host system 10 and remote system 20 may communicate over any network connection or a communication link 30, which may be a wired or wireless network connection or communication link. Remote communication between host system 10 and remote system 20 may be provided through a communication protocol running over a connection, such as Remote Frame Buffer (RFB) or similar protocol. Communication link 30 may be, for example, a local intranet within a medical facility, a service network between the medical facility and a service provider, a direct communication line between the host system 10 and the remote system 20, a virtual private network established over the Internet, the Internet itself, and so forth. In general, the communication link 30 allows data exchange between the remote system 20 and one or more components of the host system 10. As will be appreciated by those skilled in the art, any suitable circuitry, such as modems, servers, firewalls, VPN's and so forth may be included within the communication link 30.

The remote system 20 may be any type of applications based computer or processor based components capable of interacting and displaying the contents of the host system 10. Examples of well known computing system environments or configurations which may be suitable for a remote system 20 include, but are not limited to, personal computers, server computers, hand held or laptop devices, multiprocessor based systems, microprocessor systems, set top boxes, programmable consumer electronic devices, network computers, mini computers, mainframe computers, embedded systems, distributed computer environment and the like. Remote system 20 may be accessed and operated by a remote user such as service engineer or instructor.

The operations (e.g., via a user interface) of the host system 10 can be viewed using the remote system 20. The remote system 20 may include one or more general purpose or application specific computers 22 or processor-based components. The remote system 20 may also include a monitor or other visual display 24 (e.g., a CRT tube monitor, an LCD display screen or other type of visual display) and one or more input devices 26 (e.g., a mouse, keyboard, joystick, track ball, touch activated screen, light wand, voice control, or any other similar or equivalent input device). The display 24 and input devices 26 may be used for viewing host system user interfaces, viewing and inputting configuration information or for operating the host system 10, in accordance with the techniques discussed herein. The remote system 20 may comprise or communicate with a memory 28 or data storage component for storing programs and routines executed by the remote system 20 or by associated components of the host system 10. It should be understood that any type of computer accessible memory or storage device capable of storing the desired amount of data and/or code may be accessed by the remote system 20. Moreover, the memory or storage device may comprise one or more memory devices, such as magnetic or optical devices, of similar or different types, which may be local and/or remote to the remote system 20.

It should be noted that more than one remote system 20 may be provided. For example, multiple users at multiple remote systems 20 may access host system 10. A service engineer may access host system 10 using a first remote system and an instructor may access host system 10 using a second remote system.

The host system 10 may be, for example, any medical imaging system including a CT imaging system, an MRI imaging system, a tomosynthesis system, an EBT imaging system, a PET imaging system, a digital imaging system, or other medical imaging system or modality. Host system 10 comprises an imager 12, which is configured to detect a signal(s) and convert the signal(s) into useful information, for example physiological images. Imager 12 may be configured to operate in accordance with an appropriate imaging technology for the host system 10. The host system 10 also comprises a host processor 14 that is coupled to the imager 12 and configured to process data received from the imager 12. Host processor 14 is also configured to perform various input/output, control, analysis and other functions to be described herein.

The host system 10 includes a display 19 (e.g., a CRT tube monitor, an LCD display screen or other type of visual display) configured to display various host system user interfaces, such as a graphical user interface (GUI). Host system 10 may be configured to provide one or more user interfaces for different operations and functions. For example, an imaging scanner or station may include an interface which permits regulation of the parameters involved in the image data acquisition procedure, whereas a different operator interface may be provided for manipulating, enhancing, and viewing the resulting reconstructed images. Each user interface may include various components or widgets, for example, windows, buttons, text boxes, menus, dialog boxes, etc. which may be used to interact with host system 10.

The host processor 14 may work with a controlling device 16 in host system 10 for coordinating the process with patient or table movements, circuits for controlling the position of a radiation source, detectors and so forth. The host system 10 also includes memory devices 18 for storing programs and routines that can be executed by the processor 14 or any other element associated with the host system 10. The system memory 18 includes computer storage media in the form of volatile and/or non-volatile memory such as ROM 30 and RAM 32. A basic input/output system (BIOS) or operating system 34 contains the basic routine that helps to transfer information between elements within the host system 10 such as during startup. Operating system 34 is typically stored in ROM 30. RAM 32 may contain program data 38 and/or application programs (or program modules) 36 that are immediately accessible to and/or presently being operated on by the host processor 14. In general the host system 10 has a variety of computer readable medium including volatile, non-volatile, removable and non-removable media. This may be comprised of routines, programs, objects, components, data structures, etc. that perform particular tasks or implement particular abstract data types.

The host system 10 runs a remote system application routine 100 that may be stored in the host system memory 18. Remote system application routine 100 is initialized or installed by the host operator or host system (e.g., automatically) on a need basis. For example, the remote system application routine 100 may be initiated when remote system 20 wants to communicate and interact with the host system 10. In one embodiment, a user of host system 10 may initialize remote system application routine 100 when there is a need to interact with remote system 20 (e.g., when the host system needs to communicate with the remote system or in response to a request from the remote system). Alternatively, remote system application routine 100 may be initialized automatically in response to a request received from remote system 20.

Remote system application routine 100 is generally configured to provide limiting or guarding of a remote display of a host system user interface, e.g., a medical diagnostic imaging system user interface. One or more interface regions (e.g., a component or components) of the host system user interface may be designated as limited remote access interface regions. In particular, both static interface regions and dynamically created interface regions may be designated as limited remote access interface regions. The unique location or identifying designation of restricted (e.g., limited access) objects, components, pixels or screen locations are hereinafter referred to as limited remote access interface regions. Remote system application routine 100 is configured to modify the limited remote access interface regions present in screen data (e.g., GUI data) sent to a remote system 20 for display such that when the limited remote access interface regions are displayed they visually differ from respective unmodified interface regions. The modified interface regions may be displayed at the remote system 20 for viewing by a remote operator. Systems and computer programs that afford functionality of the type defined by this method are also provided by the present technique.

A configuration file is used to store component identifiers of the host system user interface components or regions which are designated as limited remote access interface regions. The host system 10 (e.g., a GUI application running on the host system 10) automatically assigns a component identifier to each host system user interface region or component created. A component identifier (or widget identifier) may be a unique identification number, such as a hexadecimal number. In addition, the host system 10 assigns a security level to each user interface region or component created or utilized by the host system 10. In one embodiment, a host system user interface region is designated as a limited remote access interface region based on the security level of the host system interface region. For example, a component such as a “Confirm” button may be created and assigned a high security level. Based on the high security level, the “Confirm” button may be designated as a limited remote access interface region and the component identifier of the “Confirm” button stored in the configuration file. The configuration file includes a component identifier for each limited remote access interface region. The configuration file may be stored in the system memory 18 of the host system 10.

Host system user interface components or regions may be created before or after the initialization of the remote system application routine 100. When initialized, a start up script of the remote system application routine 100 identifies the component identifiers of the existing host system user interface regions that should be designated as limited remote access interface regions. For example, a host system user interface region may be designated as a limited remote access interface region based on the security level of the user interface region. The component identifiers of the host system user interface regions with limited remote access are stored in the configuration file. The remote system application routine then reads the configuration file and modifies the user interface components identified in the configuration file to provide the appropriate guarding to these components. The modified user interface regions or components are transmitted to the remote system 20 via the communication link 30.

To provide security to host system user interface regions dynamically created after the remote system application routine 100 is initialized, the host system 10 is configured to identify the creation or start up of user interface regions. The host system 10 (e.g., a GUI application operating on the host system 10) determines when a user interface region is created and whether the user interface region should be designated as a limited remote access interface region. If a limited remote access interface region is identified, the component identifier of the limited remote access interface region is stored in the configuration file. If the remote system application routine 100 is installed and running, a detect signal is generated by the host system 10 and transmitted to the remote system application routine 100. Upon receiving the detect signal, the remote system application routine 100 reads the configuration file and modifies the user interface components identified in the configuration file (i.e., the limited remote access interface regions), including the newly generated limited remote access interface regions, to provide the appropriate guarding to these components. The modified user interface regions or components are then transmitted to the remote system 20 via communication link 30.

The guarding of host system user interface regions (e.g., the regions identified as limited remote access interface regions) includes allowing portions of the host system user interface screens to be specified for monitoring or for modification when displayed remotely. Based on the graphical user interface (GUI) utilized by the software and control programs of the remote system application routine 100, portions of the host system user interface may be designated for modification, masking, monitoring, and so forth based on the selected communication pipe, i.e., local or remote connections. The data sent to a remote system for display is modified according to the limited remote access interface regions. In particular, portions of the display screen corresponding to host system user interface components, such as buttons, menu selections, sliders, and so forth, or data screens, such as patient name, may be designated for modification. In one embodiment, a command interface, typically local to the host system 10, may be present which allows an operator to designate host system user interface regions for special handling by the guarding process. The host system user interface components designated as limited remote access interface regions may be, for example, a component, particular pixels or Cartesian coordinates corresponding to a portion of the user interface screen to be regulated. Alternatively, the restricted status may be a property of standardized objects, depending on the GUI employed, which may be set to restrict remote access.

Examples of the types of differential handling that may be implemented by the guarding or modification process include blocking and guarding functions. For example, blocking a host system user interface region would prevent the display of the host system user interface region on the remote system 20 and would prevent user action in the host system user interface region, i.e., selecting or clicking on a masked button. Similarly, guarding a host system user interface region would prevent user action in the interface region, however the contents of the guarded interface region may be visible to the remote operator. To allow a remote operator to know that an interface region is guarded, however, the guarded interface region may be visually differentiated, such as by differential coloring, tinting, brightness, patterning, hatching, shading, and so forth.

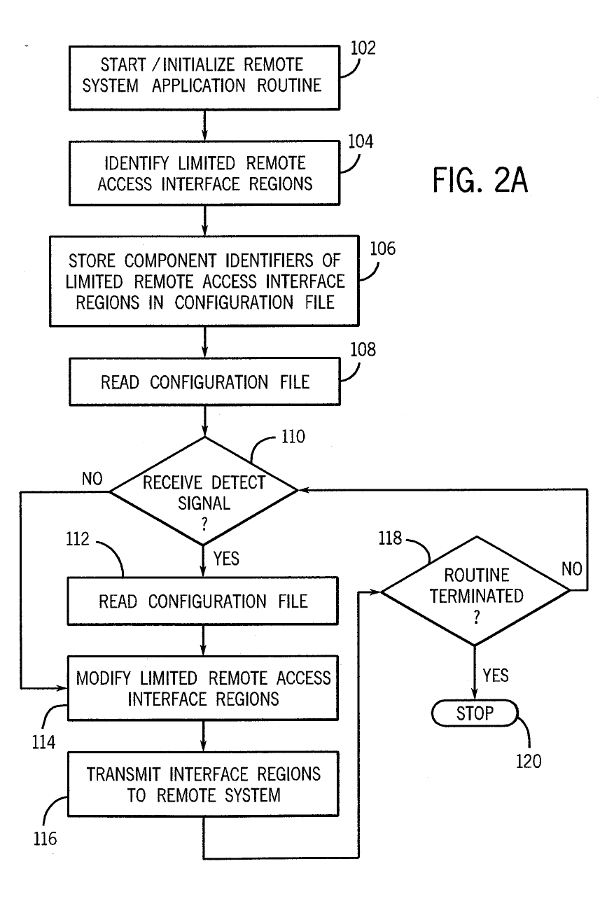

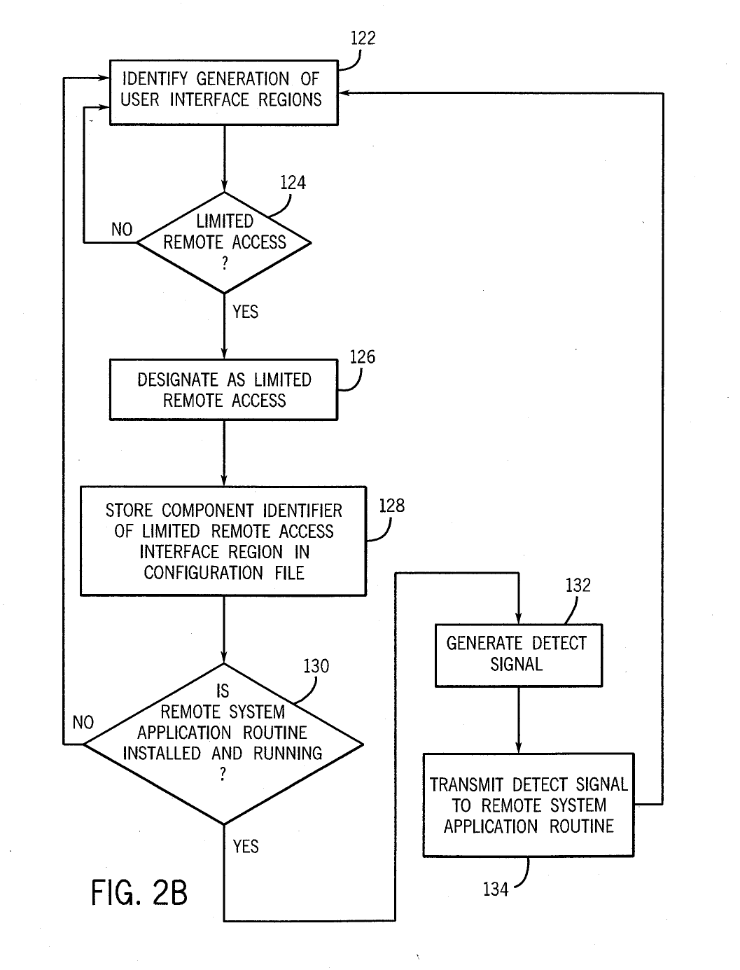

FIGS. 2A and 2B are flowcharts illustrating a method of providing security for interface regions of a host system user interface in a remote communication system in accordance with an embodiment. FIG. 2A illustrates the process of the remote system application routine 100 (shown in FIG. 1). At block 102, the remote system application routine is initialized on the host system. As discussed previously, the remote system application routine is initialized when it is required. For example, the remote system application routine may be initialized in response to receiving a request from a remote system or when the host system wishes to communicate with a remote system. In one embodiment, the remote system application routine may be initialized by a user of the host system. The remote system application routine is configured to read a configuration file stored in memory of the host system in order to determine which components or regions of the host system user interface have been identified as limited remote access interface regions.

As discussed earlier, host system user interface regions may be generated or started before or after the initialization of the remote system application routine. At block 104, a start up script of the remote system application routine is executed and identifies the existing host system user interface regions that should be designated as limited remote access interface regions. In particular, the start up script identifies the component identifiers of host system user interface regions that should be designated as limited remote access interface regions. In one embodiment, the user interface region is identified as a limited remote access interface region based on the security level of the user interface region. At block 106, the component identifiers of the identified limited remote access interface regions are appended to or stored in the configuration file. Then, at block 108, the remote system application routine reads the configuration file. The components or regions identified in the configuration file (i.e., the limited remote access interface regions) that are part of display screen data to be sent to the remote system for display will be modified by the remote system application routine before being transmitted to the remote system for display.

If a host system user interface region that requires guarding (i.e., a limited remote access interface region) is generated after the initialization of the remote system application routine, the configuration file will not include the component identifier of the newly created limited remote access interface region. In order to provide security to host system user interfaces or interface regions created dynamically after the remote system application routine has been initialized, the remote system application routine checks to determine if a detect signal has been received at block 110. The host system, for example, an application or program running on the host system such as a GUI application, is configured to identify the creation of user interface components and to store the component identifier of a dynamically created user interface region in the configuration file if it is determined to be a limited remote access interface region. The host system generates a detect signal to indicate the detection of a dynamically created limited remote access interface region. The detect signal is transmitted to the remote system application routine by the host system. The process for monitoring the generation of user interface regions and generating a detect signal is described further below with respect to FIG. 2B.

Upon receipt of a detect signal at block 110, the remote system application routine reads the configuration file at block 112. The configuration file now includes component identifiers of dynamically created limited remote access interface regions. As discussed previously, the remote system application routine is capable of providing guarding to the host system user interface regions that are designated as limited remote access interface regions. At block 114, the remote system application routine modifies the limited remote access interface regions included in the screen data sent to the remote system for display. Different limitations or security (e.g., guarding or blocking) may be placed on the limited remote access interface regions. At block 116, the remote system application routine transmits the display screen data of the host system user interface to the remote system via, for example, a communication link. If a detect signal is not received at block 110, the remote system application routine will modify (block 114) and transmit (block 116) the limited remote access interface regions identified in the configuration file to the remote system.

At block 118, it is determined whether the remote system application routine has been terminated. As mentioned previously, the remote system application routine is initialized and run when needed, for example, when the host system is communicating with a remote system. If the remote system application routine has not been terminated, the process returns to block 110 and the remote system application routine checks to determine if a detect signal has been received from the host system. If the remote system application routine has been terminated, the process stops at block 120.

FIG. 2B illustrates a method of identifying the generation of limited remote access interface regions in accordance with an embodiment. At block 122, the host system (e.g. a GUI application operating on the host system) identifies the generation of host system user interface regions or components (e.g., dynamically created user interface regions). If a host system user interface region has been identified at block 122, the host system determines whether the host system user interface region should be designated a limited remote access interface region at block 124. If the host system user interface region is not a limited remote access interface region, then the process returns to block 122 and the host system continues to identify the generation of host system user interface regions. If the host system user interface region should be a limited remote access interface region, then the host system interface region is designated as a limited remote access interface region at block 126. The component identifier of the limited remote access interface region is then stored in the configuration file at block 128. Upon detection of the generation of a limited remote access interface region, the host system will generate a detect signal. At block 130, a determination is made whether the remote system application routine is installed and running before the host system generates and sends a detect signal. As mentioned previously, the remote system application routine is in initialized on a need basis. If the remote system application routine is not installed and running, then a detect signal is not generated and the process returns to block 122 and the host system continues to identify the generation of host system user interface regions. If the remote system application routine is installed and running, then a detect signal is generated at block 132. At block 134, the detect signal is transmitted by the host system to the remote system application routine to indicate the detection of the creation of a limited remote access interface region. Upon receipt of the detect signal, the remote system application routine will read the configuration file as discussed above with respect to FIG. 2A. In FIG. 2B, once the detect signal is transmitted at block 134, the process returns to block 122 and the host system continues to identify the generation of host system user interface regions.

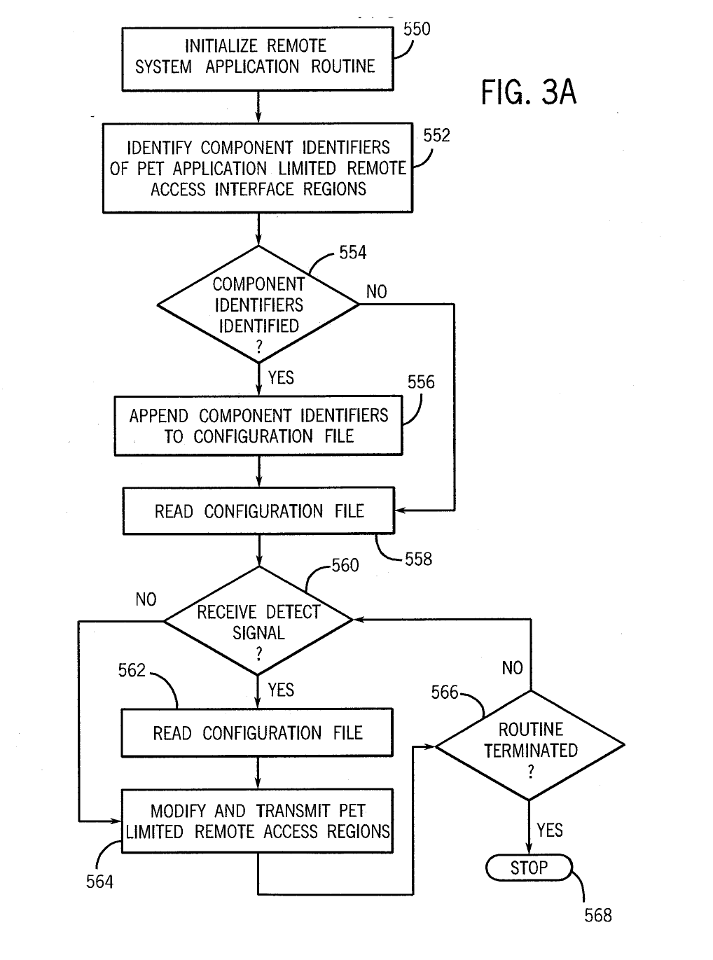

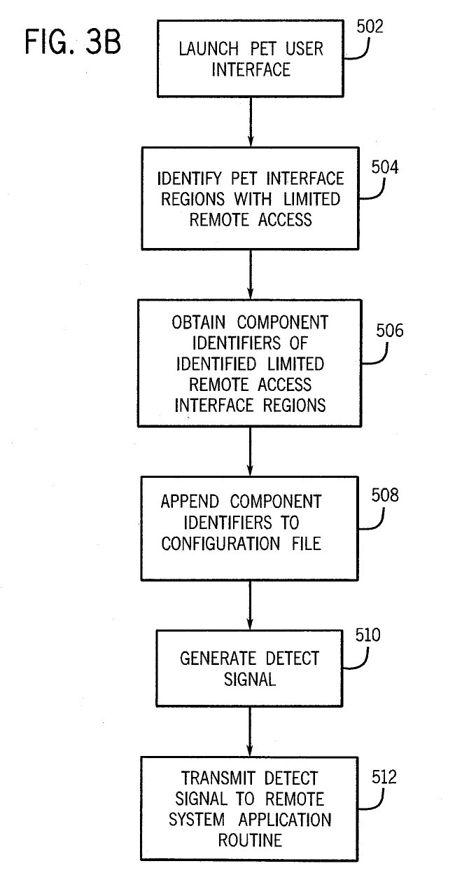

FIGS. 3A and 3B are flowcharts illustrating a method of providing security for interface regions of a PET application user interface in a remote communication system in accordance with an exemplary embodiment. In this embodiment, the host system is a PET imaging system and includes a PET application. FIG. 3A illustrates the process of a remote system application routine in a PET imaging system. As mentioned previously, the PET application user interface regions may be generated before or after the initialization of the remote system application routine. The remote system application routine includes a start up script represented by blocks 552-556 in FIG. 3A.

At block 550 in FIG. 3A, the remote system application routine is initialized and a start up script is executed. At block 552, the start up script attempts to identify and obtain the component identifiers (or window identifiers) of the PET application user interface regions that should be designated as limited remote access interface regions. If the attempt to obtain the component identifiers of the limited remote access interface regions is successful at block 554, the component identifiers are appended to the configuration file at block 556. The configuration file may be stored in memory of the PET imaging system. The remote system application routine reads the configuration file at block 558 and then provides the appropriate modification to the limited remote access interface regions identified in the configuration file. For example, a limited remote access interface region may be blocked so that a remote user of the remote system cannot control or view that area of the user interface screen. Alternatively, the limited remote access interface region may be guarded so that the remote user can view but not control the user interface region.

At blocks 560-568, the remote system application routine checks for a detect signal in a similar manner as that described above with respect to FIG. 2A. The detect signal indicates that a dynamically generated limited remote access interface region has been identified and the configuration file has been updated. The detect signal causes the remote system application routine to re-read the configuration file so that security may be provided to the newly generated limited remote access interface region(s).

As mentioned above, a user interface application may be started after the remote system application routine is initialized or user interface components or regions may be dynamically generated after the remote system application routine is initialized. FIG. 3B illustrates the operation of a PET application to generate a detect signal in accordance with an exemplary embodiment. In this example, a PET application user interface is started after the initialization of the remote system application routine. At block 502, the PET application including a PET user interface is launched in a host system, i.e., the PET imaging system. In one embodiment, the PET application may be launched in a platform such as the Linux® platform. Start up of the PET application includes launching a PET user interface screen. At block 504, the PET application identifies the PET user interface regions that are limited remote access interface regions. In order to identify and obtain the component identifiers of the limited remote access interface regions at block 506, the PET application registers an editres protocol event handler function “_XeditResCheckMessages.” The editres protocol helps to query the host system to obtain the component identifiers of the limited remote access interface regions of the PET application user interface. Once obtained, the component identifiers of the limited remote access interface regions are stored in the configuration file at clock 508. If the remote system application routine is installed and running, the PET application generates a detect signal at block 510 to indicate the detection of a limited remote access interface region(s). The PET application sends the detect signal to the remote system application routine at block 512. In addition, the PET application may be configured to continuously check or identify for the dynamic generation of PET user interface regions as described above with respect to FIG. 2B. Whenever a dynamically generated PET user interface region that should be limited remote access is identified, the component identifier of the limited remote access interface region is stored in the configuration file and a detect signal is sent to the remote system application routine to cause the routine to re-read the configuration file. Upon receipt of the detect signal from the PET application, the remote system application routine re-reads the configuration file. The limited remote access interface regions identified in the configuration file are modified appropriately and sent to the remote system for display.

Some of the major advantages of the invention is mentioned below:

It avoids the need to restart the remote system application routine 100 when new applications are launched after starting the remote system application routine.

It ensures that security restrictions for a remote user are enforced on all user interface (UI) components, irrespective of the order of instantiation.

It can provide security seamlessly for both static and dynamic UI components and thereby remove potential security loopholes with dynamic UI components.

The security level of the static as well as dynamic system interface regions can be configured or dynamically changed based on the expertise of the trainer (Low security level for expert trainer and high security level for a novice trainer).

The current technique also provides different security levels to the static as well as dynamic system interface regions based on the host system 10 state or background conditions. For example if the host system 10 is configured to work in a low-risk mode or if the room conditions are ensured to provide low risk remote access, the remote system 20 access can have relaxed security.

Thus, various embodiments of this invention provide a method for selectively guarding static interface regions and dynamic interface regions in a host system having a host system user interface. Further embodiments of this invention provide a remote communication system with enhanced security.

It should be noted that although the flow charts provided herein show a specific order of method steps, it is understood that the order of these steps may differ from what is depicted. Also, two or more steps may be performed concurrently or with partial concurrence. It is understood that such variations are within the scope of the invention.

While this invention has been described with various specific embodiments, it will be obvious for a person skilled in the art to practice the invention with modifications. However, all such modifications are deemed to be within the scope of the claims given herein.

What is claimed is:

1. A method for selectively guarding static interface regions and dynamically created interface regions in a host system having a host system user interface, comprising:
designating at least one static interface region of the host system user interface as a limited remote access interface region;
identifying creation of the dynamically created interface regions of the host system user interface while the host system is in operation;
designating at least one dynamically created interface region of the host system user interface as a limited remote access interface region; and
modifying the limited remote access interface regions present in screen data for the host system user interface to be sent to a remote system for display.

2. A method according to claim 1, wherein the step of designating at least one static interface region of the host system user interface as a limited remote access interface region further comprises identifying component identifiers of the static interface regions to be guarded and storing the component identifiers in a configuration file in the host system.

3. A method according to claim 2, wherein modifying the limited remote access interface regions further comprises reading the configuration file in the host system.

4. A method according to claim 1, wherein designating at least one dynamically created interface region of the host system user interface as a limited remote access interface region further comprises identifying component identifiers of the dynamically created interface regions to be guarded and storing the component identifiers in a configuration file in the host system.

5. A method according to claim 4, further comprising generating a detect signal upon identifying the component identifiers of the dynamically created interface regions to be guarded.

6. A method according to claim 5, wherein before the step of modifying the limited remote access regions further comprises reading the configuration file in the host system upon receipt of the detect signal.

7. A method according to claim 1, wherein each of the static interface regions and the dynamically created interface regions of the host system user interface are allocated a security level.

8. A method according to claim 1, wherein the host system includes a medical imaging system.

9. A method according to claim 8, wherein the medical imaging system is one of a CT imaging system, an MRI imaging system, a tomosynthesis system, an EBT imaging system, a PET imaging system, and a digital X-ray imaging system.

10. A method according to claim 1, wherein the host system is in communication with at least one remote system.

11. A method according to claim 2, wherein the component identifiers are unique identification numbers.

12. A computer program, provided on one or more computer readable media for selectively guarding static interface regions and dynamically created interface regions in a host system having a host system user interface, comprising:
a routine for designating at least one static interface region of the host system user interface as a limited remote access interface region;
a routine for identifying creation of the dynamically created interface regions of the host system user interface while the host system is in operation;
a routine for designating at least one dynamically created interface region of the host system user interface as a limited remote access interface region; and
a routine for modifying the limited remote access interface regions present in screen data for the host system user interface to be sent to a remote system for display.

13. A computer program according to claim 12, wherein the routine for designating at least one static interface region of the host system user interface as a limited remote access interface region comprises a routine for identifying component identifiers of the static interfaces regions to be guarded and a routine for storing the component identifiers in a configuration file in the host system.

14. A computer program according to claim 12, wherein the routine for designating at least one dynamically created interface region of the host system user interface as a limited remote access interface region comprises a routine for identifying component identifiers of the dynamically created interface regions to be guarded and a routine for storing the component identifiers in a configuration file in the host system.

15. A computer program according to claim 14, further comprising a routine for generating a detect signal upon identifying the component identifiers of the dynamically created interface regions.

16. A computer program according to claim 13, wherein the host system includes a medical imaging system.

17. A remote communication system, comprising:
a host medical imaging system having a host user interface including static user interface regions and dynamically created user interface regions, comprising:
a host processor configured to designate at least one static user interface region as a limited remote access interface region, to identify creation of the dynamically created user interface regions while the host medical imaging system is in operation, to designate at least one dynamically created user interface region as a limited remote access interface region, to identify a component identifier for each limited remote access interface region and to modify the limited remote access interface regions; and
a memory coupled to the host processor and configured to store component identifiers for limited remote access interface regions in a configuration file;
at least one remote system configured to communicate with the host medical imaging system and to display the host user interface; and
a communication link coupled between the host medical imaging system and the at least one remote system and configured to transmit the modified limited remote access interface regions to the remote system.

18. A remote communication system according to claim 17, wherein the host processor is further configured to store the component identifiers of the limited remote access interface regions in the configuration file.

19. A remote communication system according to claim 18, wherein the host processor is further configured to generate a detect signal upon designation of at least one dynamically created user interface region as a limited remote access interface region.

20. The system according to claim 17, wherein the host medical imaging system is one of a CT imaging system, an MRI imaging system, a tomosynthesis system, an EBT imaging system, a PET imaging system, and a digital X-ray imaging system.
